(19) United States
(12) Patent Application Publication
(10) Pub. No.: US 2008/0024968 A1
(43) Pub. Date: Jan. 31, 2008

(54) Loadable composite backup power system

(75) Inventor: Yung-Hsin Huang, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/519,904

(22) Filed: Sep. 13, 2006

Related U.S. Application Data
(63) Continuation-in-part of application No. 11/482,170, filed on Jul. 7, 2006.

(51) Int. Cl. G06F 1/16

(52) U.S. Cl. 361/683

(57) ABSTRACT

A loadable composite backup power system can be configured and assembled to become a small backup power system or a large backup power system according to actual requirements. In the condition of a smaller loading requirement, one power unit consisting of M+P sets of power supply devices (base and backup power supply) can be selected to connect electrically to a main power distribution unit to form the small backup power system. When the load increases, an extra power unit consisting of M+P sets of power supply devices can be added and connected to the main power distribution unit to form the large backup power system that integrates all the base and backup power supply. Hence the power expansion flexibility of the existing backup power system can be enhanced.

This application is a continuation-in-part, and claims priority from U.S. patent application Ser. No. 11/482,170 filed on Jul. 7, 2006, entitled “COMPOSITE BACKUP-TYPE POWER SUPPLY SYSTEM”

### FIELD OF THE INVENTION

The present invention relates to a backup power system and particularly to a loadable composite backup power system that is expandable flexibly according to load requirements.

### BACKGROUND OF THE INVENTION

Referring to FIG. 1, a conventional backup-type power system usually consists of a plurality of power supply devices which adopt a common structural design. Namely a plurality of power supply devices share one chassis and a controlling power integration panel. In practice a N+1 architecture is commonly adopted. Take an 1+1 architecture shown in FIG. 1 as an example. It consists of two power supply devices. In the event that one of the power supply devices malfunctions, another power supply device can still function normally to provide electric power. According to different requirements, a N+2 architecture may also be adopted.

However, the specifications of the present backup-type power system still cannot fully and flexibly meet user's expansion requirements. This is mainly because the backup specification is fixed. For instance, if a backup-type power system adopts a 3+1 architecture, in the event that the actual demand requires an 1+1 architecture, the extra two sets of power supply devices are added by taking into account of future expansion purpose. This could result in a real power supply and a dummy power supply sharing the same structure. Namely, the real power supply is the 1+1 architecture that is actually being used, while the extra two sets are dummy power supply. When user's demand increases, additional two sets of real power supply are procured to replace the dummy power supply to form the backup-type power system of the 3+1 architecture. In such a condition, the dummy power supply is useless. Moreover, in the event that the host has to be expanded to adopt a backup-type power system of 5+1 architecture, the original 3+1 architecture cannot be upgraded again. And a new backup-type power system of 5+1 architecture has to be procured. It is a heavy burden to users.

### SUMMARY OF THE INVENTION

The primary object of the present invention is to solve the aforesaid disadvantages. The present invention provides a loadable composite backup power system that can be flexibly configured and assembled to become a small backup power system or a large backup power system according to actual requirements. In the condition of a smaller loading requirement a power unit consisting of M+P power supply devices (base and backup power supply) can be chosen and electrically connected to a main power distribution unit to form a small backup-type power system. When the load increases, an extra power unit consisting of M+P power supply devices can be added and linked to the main power distribution unit. Thereby the power expansion flexibility of the backup power system can be greatly enhanced.

To achieve the foregoing object, one embodiment of the invention includes a main power chassis which is partitioned to form a plurality of main loading compartments and a main power distribution unit located on an inner side of the main loading compartments. The main power distribution unit has main power input ports on one side where the main loading compartments are located corresponding to the number of the main loading compartments, and a main power output port on another side thereof. The main loading compartments have at least one loadable power unit which has a sub-chassis. The sub-chassis is partitioned to form a plurality of sub-loading compartments. The sub-chassis has a sub-power distribution unit on one side where the sub-loading compartments are located. The sub-power distribution unit has a plurality of sub-power input ports on one side where the sub-loading compartments are located corresponding to the number of the sub-loading compartments, and a sub-power output port on another side electrically connecting and corresponding to the main power input port. A plurality of power supply devices also is provided that are loadable in the sub-loading compartments. Each of the power supply devices has a secondary power output port corresponding and electrically connected to the sub-power input port. The loadable composite backup power system thus formed integrates all the base power supply and backup power supply.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional backup power system.

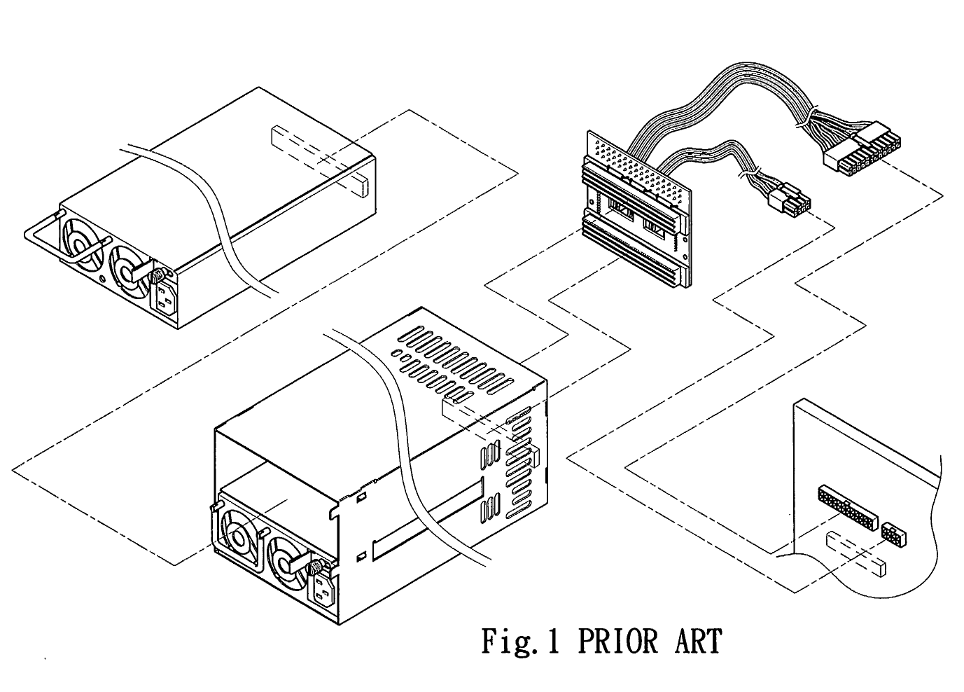

FIG. 2 is an exploded view of the invention.

FIG. 3 is a schematic view of the sub-power distribution unit of the invention.

FIG. 4 is a perspective of the sub-power distribution unit of the invention.

FIG. 5 is a schematic view of the power system of the invention in an assembled condition.

### DETAILED DESCRIPTION OF THE PREFERRED EMBODIMENT

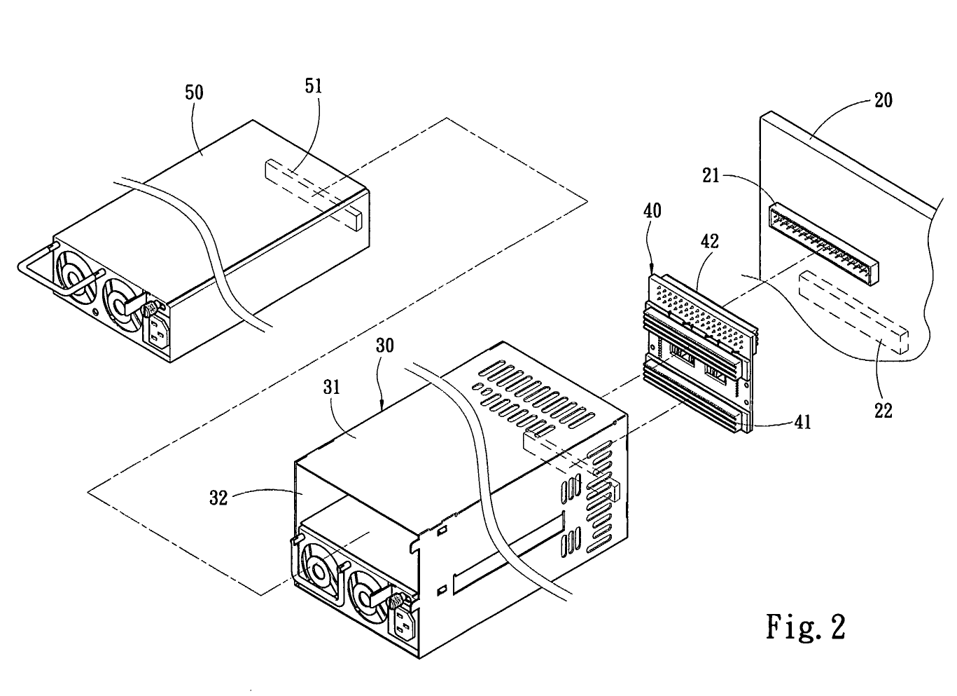

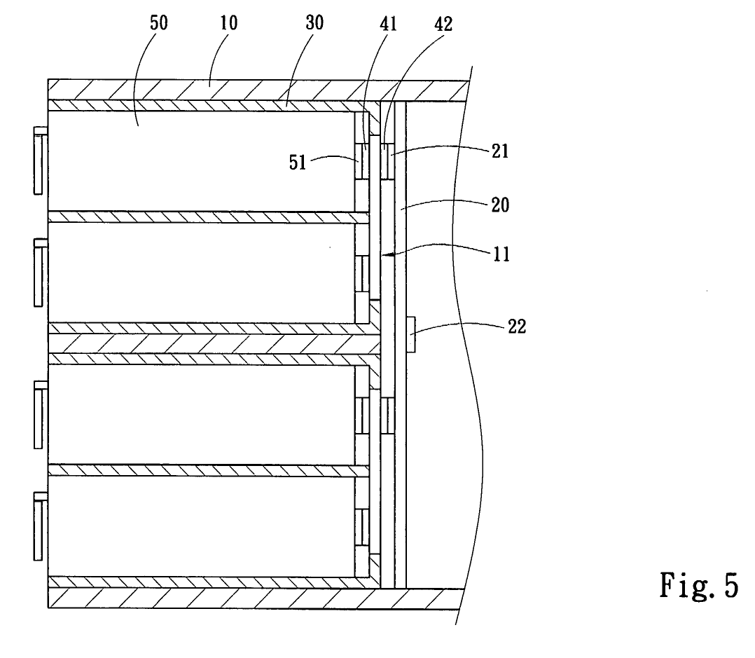

Please refer to FIGS. 2 and 5, the loadable composite backup power system of the invention includes a main chassis 10 which is partitioned to form a plurality of main loading compartments 11. On an inner side of the main chassis 10 where the loading compartments 11 are located, there is a main power distribution unit 20. The main power distribution unit 20 has main power input ports 21 on one side where the main loading compartments 11 are located corresponding to the number of the main loading compartments 11, and a main power output port 22 on another side. The main power output port 22 may be a coupling slot, gold finger or wire to output power for external electronic devices.

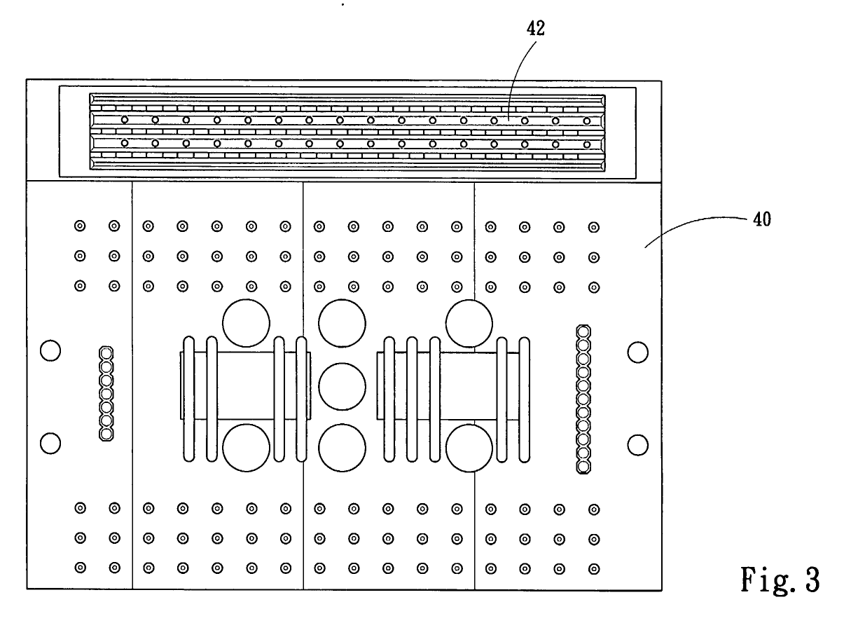

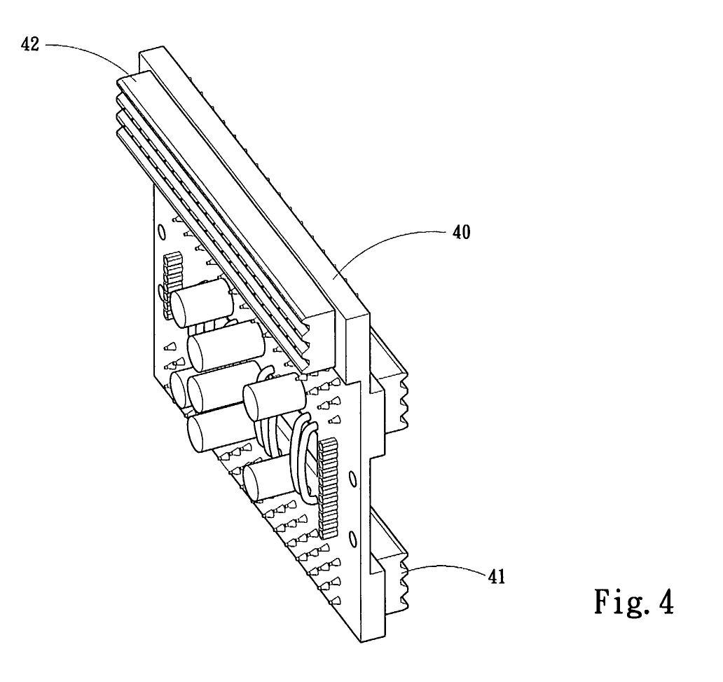

The main loading compartments 11 house at least one loadable power unit 30. FIG. 5 shows that the main power chassis 10 holds two power units 30. Each power unit 30 has a sub-chassis 31 partitioned to form a plurality of sub-loading compartments 32. The sub-chassis 31 has a sub-power distribution unit 40 on an inner side where the sub-loading compartments 32 are located as shown in FIGS. 3 and 4. The sub-power distribution unit 40 has sub-power input ports 41 on one side where the sub-loading compartments 32 are located corresponding to the number of the sub-loading compartments 32, and a sub-power output port 42 on another side. The sub-power output port 42 is corresponding and electrically connected to the main power input port 21. A plurality of power supply devices 50 are housed in the sub-loading compartments 32 in a loadable manner. The power supply devices 50 are divided into base power supply and back-up power supply. Each of the power supply devices 50 is electrically connected to a secondary power output port 51 of the corresponding sub-power input port 41.

The invention can be configured and assembled according to actual requirements to become a small backup power system or a large backup power system. In the condition of a smaller loading condition, the power unit 30 consisting of M+P sets of power supply devices (base and backup power supply) may be selected and electrically connected to the main power distribution unit 20 to form a small backup power system. In the event that the load increases, an extra power unit 30 consisting of M+P sets of power supply devices 50 can be added and connected to the main power distribution unit 20. Thereby the expansion flexibility of the existing backup power system can be enhanced to meet the dynamic requirements of varying systems. The main power output port 22, main power input port 21, sub-power output port 42, sub-power input port 41 and secondary power output port 51 may be coupling slots, gold fingers or wires to transmit power. The power unit 30 of the main chassis 10 and the power supply devices 50 in each power unit 30 may be configured according to requirements. The drawings serve only illustrative purpose and are not the limitation of the invention. While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A loadable composite backup power system, comprising:
a main chassis which is partitioned to form a plurality of main loading compartments and has a main power distribution unit on an inner side where the main loading compartments are located, the main power distribution unit having main power input ports on one side where the main loading compartments are located corresponding to the number of the main loading compartments and a main power output port on another side thereof;
at least one loadable power unit which is located in the main loading compartments and has a sub-chassis partitioned to form a plurality of sub-loading compartments, the sub-chassis having a sub-power distribution unit on an inner side where the sub-loading compartments are located, the sub-power distribution unit having sub-power input ports on one side where the sub-loading compartments are located corresponding to the number of the sub-loading compartments and a sub-power output port on another side corresponding and electrically connected to the main power input port; and
a plurality of power supply devices housed in the sub-loading compartments in a loadable manner, each of the power supply devices having a secondary-power output port corresponding and electrically connected to the sub-power input port.

2. The loadable composite backup power system of claim 1, wherein the secondary power output port is a gold finger.

3. The loadable composite backup power system of claim 1, wherein the secondary power output port is a coupling slot.

4. The loadable composite backup power system of claim 1, wherein the sub-power output port is a gold finger.

5. The loadable composite backup power system of claim 1, wherein the sub-power output port is a coupling slot.

6. The loadable composite backup power system of claim 1, wherein the main power output port is a power transmission line.

7. The loadable composite backup power system of claim 1, wherein the main power output port is a coupling slot.
